(19) United States
(12) Patent Application Publication
(10) Pub. No.: US 2026/0264893 A1
(43) Pub. Date: Sep. 10, 2026

(54) Adaptable Space Vehicle Payload Interface

(71) Applicant: Ecoatoms, Inc., Reno, NV (US)

(72) Inventors: Solange Massa, Reno, NV (US); Aram Garibyan, Reno, NV (US); Ebrahim Kayali, Reno, NV (US); Joseph Pierce Vincent, Reno, NV (US)

(73) Assignee: Ecoatoms, Inc., Reno, NV (US)

(21) Appl. No.: 19/558,283

(22) Filed: Mar. 5, 2026

Related U.S. Application Data
(60) Provisional application No. 63/768,790, filed on Mar. 7, 2025.

(51) Int. Cl. B64G 1/64; B64G 1/42; B64G 7/00; G06F 3/04847; H02M 3/00

(52) U.S. Cl. CPC B64G 1/641; B64G 1/428; B64G 7/00; G06F 3/04847; H02M 3/00

(57) ABSTRACT

In some embodiments of the invention, a space vehicle payload interface includes an onboard computer including a field-programmable gate array (FPGA) and one or more processors, a network port configured to provide data connectivity to a space vehicle, an input power connector configured to receive power from the space vehicle, a plurality of DC-DC power converters each configured to convert input power from the input power connector to a different output voltage, a plurality of peripheral connectors configured to connect to peripherals, and memory coupled to the onboard computer, wherein the onboard computer is configured to control connected peripherals according to a programmed sequence and to provide data from the peripherals to the space vehicle through the network port.

### RELATED APPLICATIONS

This application claims priority to U.S. Provisional Patent Application No. 63/768,790, entitled Adaptable Space Vehicle Payload Interface, filed Mar. 7, 2025, which is hereby incorporated by reference in its entirety.

### FIELD OF THE INVENTION

The present invention relates generally to space vehicle electronics and more specifically to interfaces between the space vehicle electrical system and electronics of a payload in the space vehicle.

### BACKGROUND OF THE INVENTION

Space vehicles play a crucial role in scientific research, technological advancements, and commercial endeavors beyond Earth's atmosphere. These vehicles, such as satellites, space probes, manned and unmanned spacecraft, space stations, and lunar landers, often carry a variety of payloads designed for specific missions. In many cases, payloads include scientific instruments and experimental modules that require electrical power and data connectivity to operate effectively in the harsh conditions of space. One critical area of research involves chemical, biological and component experiments conducted in microgravity and high radiation environments or other space environments to study the effects of space travel on electrical components, chemical experiments, living organisms, cellular processes, and other developments.

Traditionally, integrating experimental payloads and scientific peripherals into space vehicles for edge computing has presented significant challenges. Each payload often has unique power requirements, communication protocols, and data-handling needs. As a result, extensive customization is required to ensure compatibility between the spacecraft's systems and the onboard peripherals. This leads to increased costs, extended development cycles, and potential inefficiencies in payload utilization. Furthermore, the lack of a standardized interface means that updating or replacing scientific equipment can require substantial modifications to the vehicle's existing infrastructure, limiting flexibility for future missions.

### SUMMARY OF THE INVENTION

Adaptable space vehicle payload interfaces in accordance with embodiments of the invention are disclosed. In one embodiment, a space vehicle payload interface is provided. In this embodiment, the space vehicle payload interface includes an onboard computer including a field-programmable gate array (FPGA) and one or more processors. The space vehicle payload interface further includes a network port configured to provide data connectivity to a space vehicle. The space vehicle payload interface also includes an input power connector configured to receive power from the space vehicle. The space vehicle payload interface additionally includes a plurality of DC-DC power converters each configured to convert input power from the input power connector to a different output voltage. The space vehicle payload interface further includes a plurality of peripheral connectors configured to connect to peripherals. The space vehicle payload interface also includes memory coupled to the onboard computer. The onboard computer is configured to control connected peripherals according to a programmed sequence and to provide data from the peripherals to the space vehicle through the network port.

In other embodiments, the space vehicle payload interface may include one or more of the following features. The memory may be error-correcting code (ECC) RAM. The network port may be an Ethernet port. The Ethernet port may be a 1000Base-T Ethernet port. The input power connector may be configured to receive input power in a range of 18 V DC to 60 V DC. The plurality of DC-DC power converters may be configured to provide output voltages including 5 V, 12 V, and 28 V. The plurality of DC-DC power converters may utilize a dual phase buck converter topology with dual inductor outputs. The plurality of peripheral connectors may include at least one of a sensor connector configured to connect to a sensor, a USB port configured to connect to a USB device, a motor controller connector configured to connect to a motor, and a thermoelectric cooler connector configured to connect to a thermoelectric cooler. The sensor connector may be configured to connect to at least one of an oxygen sensor, a carbon dioxide sensor, a humidity sensor, a pressure sensor, a temperature sensor, and an inertial measurement unit. The motor controller connector may be configured to connect to at least one of a brushed DC motor, a stepper motor, and a linear actuator. The onboard computer may be configured to store multiple FPGA configurations and to dynamically load an FPGA configuration based on connected peripherals. The onboard computer may utilize device tree overlays to manage the multiple FPGA configurations. The space vehicle payload interface may further include an RS422 serial interface for telemetry and telecommand communication with the space vehicle. The onboard computer may be configured to operate in a passthrough mode in which the space vehicle payload interface provides passthrough power to a connected payload, or a plug-n-play mode in which the onboard computer controls connected peripherals according to the programmed sequence.

In another embodiment, a method for operating a space vehicle payload interface is provided. In this embodiment, the method includes receiving power from a space vehicle through an input power connector. The method further includes converting the received power to a plurality of output voltages using one or more DC-DC power converters. The method also includes identifying peripherals connected to a plurality of peripheral connectors. The method additionally includes loading an FPGA design to a field-programmable gate array based on the identified peripherals. The method further includes executing a programmed sequence to control the connected peripherals. The method also includes transmitting data from the connected peripherals to the space vehicle through a network port.

In other embodiments, the method may include one or more of the following features. Converting the received power may include converting input power in a range of 18 V DC to 60 V DC to output voltages including 5 V, 12 V, and 28 V. The method may further include receiving a user-created programmed sequence through a graphical user interface and storing the programmed sequence in memory prior to executing the programmed sequence. Receiving the user-created programmed sequence may include receiving a code-less sequence created using a block editor in the graphical user interface. Executing the programmed sequence may include operating in one of a user-driven mode in which events are manually triggered and sequences are scheduled to start at designated times, and an autonomous mode in which the onboard computer reads a configuration file containing an itinerary of prescheduled sequences and executes sequences at designated times when all needed peripherals are connected. The method may further include displaying real-time power usage information on a graphical user interface, the real-time power usage information including current steady-state power consumption and remaining available power from the system.

In yet another embodiment, a space vehicle payload system is provided. In this embodiment, the space vehicle payload system includes a vehicle adaptor configured to interface with a space vehicle. The space vehicle payload system further includes a universal cable connected to the vehicle adaptor. The space vehicle payload system also includes an onboard computer connected to the universal cable. The onboard computer includes a field-programmable gate array (FPGA) and one or more processors. The onboard computer further includes a network port configured to provide data connectivity to the space vehicle through the vehicle adaptor. The onboard computer also includes an input power connector configured to receive power from the space vehicle through the vehicle adaptor. The onboard computer additionally includes one or more DC-DC power converters configured to convert input power to a plurality of output voltages. The onboard computer further includes a plurality of peripheral connectors configured to connect to peripherals. The onboard computer also includes memory coupled to the onboard computer. The vehicle adaptor is interchangeable to accommodate different space vehicle types.

In other embodiments, the space vehicle payload system may include one or more of the following features. The vehicle adaptor may be configured to interface with spacecraft bus interfaces, launch provider interfaces, space station interfaces, and lunar lander interfaces. The onboard computer may be configured to operate in a passthrough mode providing passthrough power to a connected payload, or a plug-n-play mode in which the onboard computer controls connected peripherals according to a programmed sequence created using a codeless graphical user interface. The graphical user interface may be configured to display real-time power usage information including current steady-state power consumption and remaining available power. The onboard computer may further include a software platform configured to recreate a mission with simulated events and triggers.

### BRIEF DESCRIPTION OF THE DRAWINGS

FIG. 1 conceptually illustrates a payload interface in accordance with an embodiment of the invention.

FIG. 2A illustrates a payload interface in accordance with an embodiment of the invention.

FIG. 2B illustrates another view of a payload interface in accordance with an embodiment of the invention.

FIG. 2C illustrates how a payload interface may be placed within a payload in accordance with an embodiment of the invention.

FIG. 3 conceptually illustrates a payload interface in accordance with an embodiment of the invention.

FIG. 4A illustrates a passthrough mode of operation of a payload interface in accordance with an embodiment of the invention.

FIG. 4B illustrates a plug-n-play mode of operation of a payload interface in accordance with an embodiment of the invention.

FIG. 4C is a chart listing types of peripherals that may be connected to a payload interface in accordance with an embodiment of the invention.

FIGS. 5A, 5B, and 5C illustrate examples of user interfaces in accordance with embodiments of the invention.

FIG. 6A illustrates a process for reconfiguring FPGAs on a payload in accordance with an embodiment of the invention.

FIG. 6B illustrates a process for executing a sequence in autonomous mode in accordance with an embodiment of the invention.

FIG. 7 illustrates a process for initializing a sequence in accordance with an embodiment of the invention.

### DETAILED DISCLOSURE OF THE INVENTION

Adaptable space vehicle payload interfaces in accordance with embodiments of the invention are disclosed. To address the challenges of adapting and connecting instruments and modules of a payload to a spacecraft, certain embodiments of the invention involve modular hardware architectures, allowing for easier interchangeability of payloads and a software platform that attempts to create a more uniform control system for different types of onboard equipment.

Embodiments of the invention introduce an interface system designed to serve as a coordinator and controller of peripherals onboard space vehicles. This interface allows for seamless integration of various biological, chemical and component experiment modules and other scientific equipment, by adapting to their specific hardware and software requirements. By providing a standardized method for power distribution, data communication, and control signal processing, adaptable payload interfaces in accordance with embodiments of the invention can enable greater flexibility in configuring and operating payloads. This approach not only simplifies the process of adding or modifying onboard scientific instruments but also enhances mission efficiency by reducing the need for custom integration work.

Moreover, embodiments of the invention address key reliability and safety concerns associated with space-based biological, chemical and component experiments. By ensuring a consistent and adaptable connection between the spacecraft's main systems and its experimental payloads, the payload interface minimizes the risk of power failures, communication disruptions, and incompatibilities. This is particularly crucial for long-duration space missions, where real-time adjustments to experimental parameters may be necessary based on evolving mission needs.

### Modular Architecture

A payload interface in accordance with embodiments of the invention may be implemented as a three-part hardware solution. A first part may include a vehicle adaptor configured to interface with a space vehicle. The vehicle adaptor may be interchangeable to accommodate different space vehicle types, including spacecraft bus interfaces, launch provider interfaces, space station interfaces, and lunar lander interfaces. A second part may include a universal cable that connects the vehicle adaptor to the onboard computer. The universal cable may provide electrical connectivity for power and data signals between the vehicle adaptor and the onboard computer. In some embodiments, the universal cable may be omitted where direct connection is possible. A third part may include the onboard computer, which may contain the FPGA, memory, and connectors for peripherals as described herein. This three-part architecture may allow payloads to transition between different space vehicles, from suborbital flights to lunar missions, with minimal adaptations. In some embodiments, only the vehicle adaptor may need to be changed when transitioning a payload between different space vehicle types, while the universal cable and onboard computer may remain the same. In this way, a system can be designed to be compatible from an electrical and mechanical standpoints with typical spacecraft bus interfaces, launch provider interfaces, space station interfaces and lunar lander interfaces.

### Space Vehicle Payload Interface Components

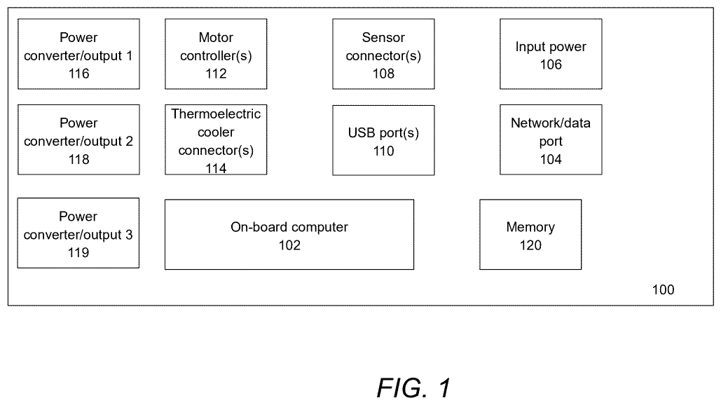

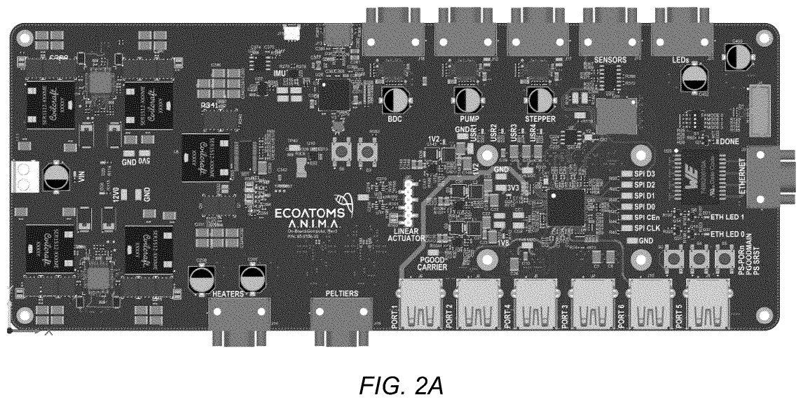

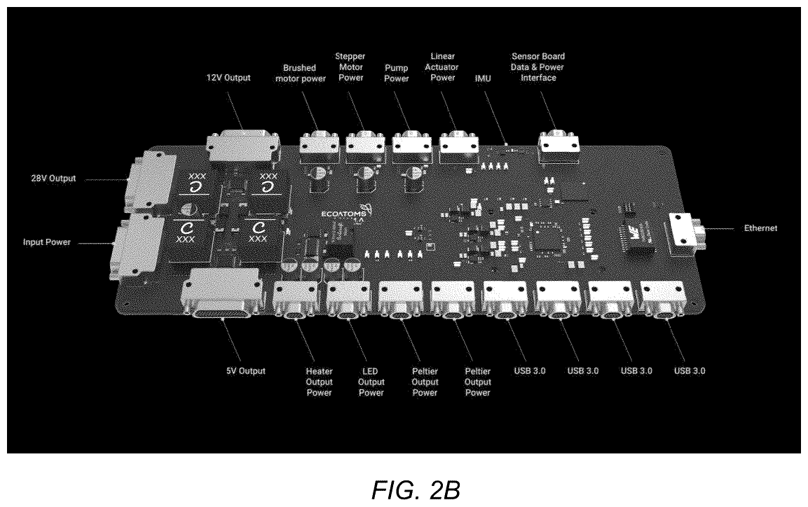

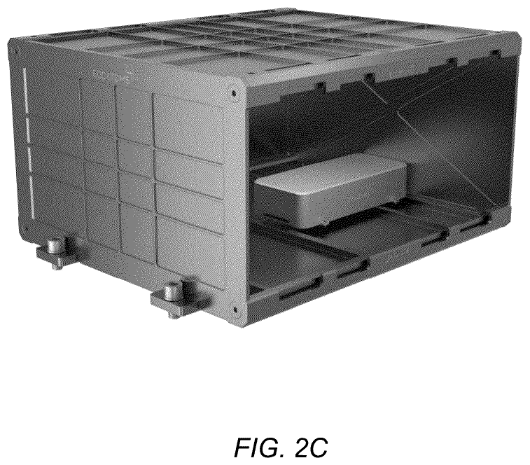

A payload interface may accept power from a space vehicle in which it is installed, provide connectivity to a finished payload and/or a set of peripherals, control connected peripherals using an onboard computer (e.g., FPGA), and feed data back to the space vehicle from the payload interface and its connected items through a data link (e.g., a network interface). A component diagram of an adaptable space vehicle payload interface in accordance with an embodiment of the invention is illustrated in FIGS. 1 and 2. The payload interface 100 includes an onboard computer 102, a network/data port 104, input power connector 106, sensor connector(s) 108, USB port(s) 110, motor controller(s) 112, thermoelectric cooler connector(s) 114, one or more power converters/outputs 116, 118, and 119, and memory 120.

In many embodiments of the invention, the onboard computer 102 includes a field-programmable gate array (FPGA) and one or more processors. An FPGA has the advantage of being reconfigurable to suit different use cases for the payload interface as designed by a user and for the peripherals that are connected. As will be discussed further below, the onboard computer may collect information, connect to peripherals and control them according to a programmed sequence, and generate a user interface. Memory 120 is provided for use by the onboard computer. In several embodiments, the memory 120 is ECC (error-correcting code) RAM.

The network/data port can provide an interface to a space vehicle. In many embodiments of the invention, the network/data port is an Ethernet port (e.g., GbE). Data from sensors and other peripherals connected to the payload interface may be provided to the space vehicle through the network/data port. Data to generate a user interface and receive user input may also pass through the network/data port. In some embodiments, the payload interface may also include an RS422 serial interface for telemetry and telecommand (TM/TC) communication with the space vehicle. Telemetry data may be transmitted using various protocols, such as Real-time Transport Protocol (RTP) for camera streams and microscope streams.

The input power connector 106 provides a connection to receive power from the space vehicle. In some embodiments, the input power is a higher voltage (e.g., 16-28 V or 18-60 V) than the voltage used by components of the payload interface. In some embodiments, the DC-DC power converters may utilize a dual phase buck converter topology with dual inductor outputs that split current between two inductors for improved efficiency and power handling. One or more DC-DC power converters/outputs 116, 118, and 119 can step down the main input voltage to voltages usable by the components. In several embodiments, a DC-DC power converter 116 can provide 5 V at up to 200 W. In certain embodiments, DC-DC power converter 118 can provide 12 V at up to 300 W. In additional embodiments, power output 119 can provide 28 V up to 550 W. One skilled in the art will recognize that any of a variety of power characteristics may be utilized in accordance with embodiments of the invention. For example, power can also be provided at 1.8 or 3.3 V.

One or more sensor connectors 108 can allow connection of sensors, such as, but not limited to oxygen (O₂), carbon dioxide (CO₂), humidity, and/or inertial measurement unit (IMU) sensors. The data from the sensors may be utilized by the onboard computer or may be provided to the space vehicle through the network/data interface. For example, a 6-axis IMU may include a 3-axis accelerometer and a 3-axis gyroscope). When the IMU provides measurements indicating zero gravity, it can indicate that the space vehicle is drifting. A humidity sensor may be utilized for biological experiments that can involve other peripherals and sensors connected to the payload interface.

One or more USB ports 110 can allow connection of peripherals that have a USB interface. In further embodiments of the invention, other types of data interfaces may be used. Peripherals such as but not limited to, cameras, microscopes, and/or linear actuators can be connected to the USB ports. The wires within USB ports are typically ground, signal, signal, ground.

One or more motor controllers 112 can be connected to any of a variety of electric motors. For example, the motors can include, but are not limited to, brushed DC, pump, and/or stepper. Electric motors often use 12 V power, which can be drawn from the 12 V power converter, although other voltages may be used.

One or more thermoelectric cooler connectors 114 can allow connection of thermoelectric coolers. A thermoelectric cooler typically includes plates surrounded by PN junctions. Through the Peltier effect, it transfers heat from one plate to the other plate. This can be used for heating or cooling, or as a temperature controller that maintains a particular temperature. These connectors typically have a power wire and a return wire.

In additional embodiments of the invention, appropriate items are connected to at least some of the corresponding connectors (e.g., O₂ sensor to the O₂ sensor connector, USB device such as a camera to a USB port, etc.).

A graphical view of a similar payload interface in accordance with an embodiment of the invention is illustrated in FIG. 2A. Another view of a payload interface in accordance with an embodiment of the invention is illustrated in FIG. 2B. FIG. 2C illustrates how a payload interface may be placed within a payload in accordance with an embodiment of the invention.

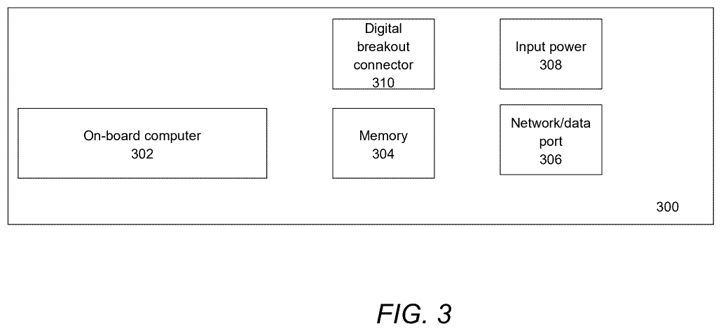

A component diagram of an adaptable space vehicle payload interface in accordance with another embodiment of the invention is illustrated in FIG. 3. The illustrated payload interface has a reduced footprint of components on the board as compared to the payload interface of FIG. 1 by reducing the number of connectors. The payload interface 300 includes an onboard computer 302, memory 304, a network/data port 306, input power connector 308, and a digital breakout connector 310. The onboard computer 302, memory 304, a network/data port 306, and input power connector 308 may be similar to those described further above with respect to FIG. 1. Input power connector 308 and/or digital breakout connector 310 may utilize a standard connector type such as military spec D38999. Input power connector 308 may include pins for source voltage from the space vehicle, ground, and 5V output passthrough, 12V output passthrough, and/or 28V output passthrough. Digital breakout connector 310 can provide sensor connector(s), USB port(s), motor controller(s), thermoelectric cooler connector(s), and one or more power converters/outputs. The additional connectors can be provided at the end of a pigtail wiring harness connected to the digital breakout connector, or they can be on another circuit board connected to the digital breakout connector.

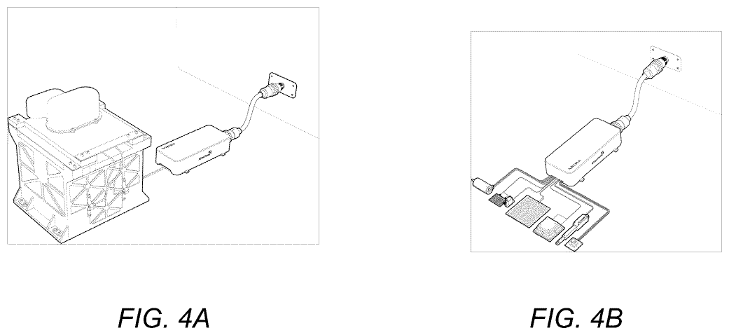

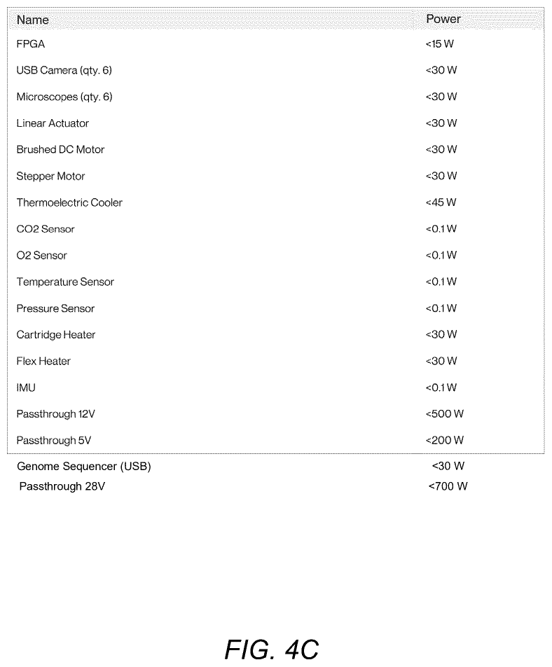

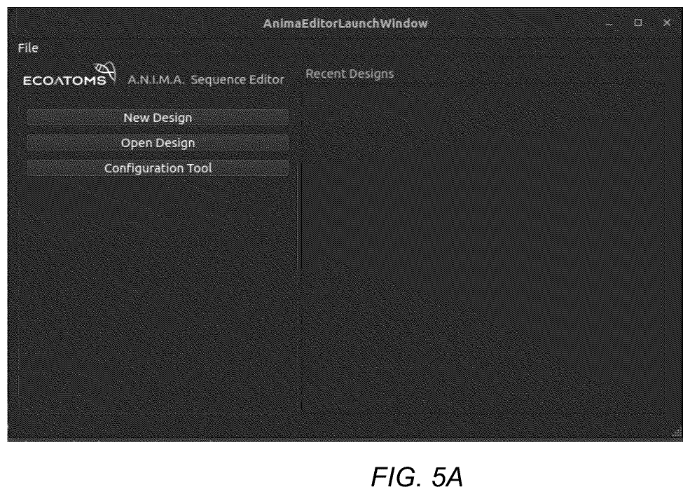

The payload interface may operate in passthrough or plug-n-play mode in some embodiments of the invention. A passthrough mode is illustrated in FIG. 4A. Passthrough mode can be used for connecting a finished payload and allows for direct interaction with the source code. The payload interface is used as an adaptor and voltage regulator to provide passthrough power. A plug-n-play mode is illustrated in FIG. 4B. Plug-n-play mode is designed for non-traditional aerospace users (biological/biochemical/educational experiments) to plug different peripherals onto the payload interface and interact with the codeless platform to design their experiments. Further embodiments of the invention can provide some ratio of dividing power between passthrough and plug-n-play modes.

FIG. 4C is a chart showing an example list of peripherals and connections on a payload interface in accordance with an embodiment of the invention.

Although specific configurations of payload interfaces are described above with respect to FIGS. 1 through 4C, one skilled in the art will recognize that any of a variety of configurations may be utilized in accordance with embodiments of the invention as appropriate to a particular application.

### Payload Interface Software

Software components, some of which can be implemented as firmware, of a payload interface can include an operating system (OS) kernel (e.g., Linux), libraries, FPGA hardware designs, and a user interface. In certain embodiments of the invention, the software can be executed on one or more processors, one or more microprocessors and an FPGA fabric. Additional software can manage interrupt handling between the FPGA and processors.

The libraries can provide an interface from the OS service to the FPGA for peripheral interfacing. They can be implemented as local server APIs (application programming interface) that respond to commands or API calls (e.g., “set motor” command returns “motor was set”, “get sensor data” command). The designed sequences can direct the peripherals using the APIs.

Hardware designs can refer to images of an FPGA that configure circuits into the FPGA suitable for programmatic tasks. For example, if a camera is being used, a portion of the FPGA can be configured for image processing acceleration for the image sensor data. In some embodiments of the invention, hardware designs can be shown as selectable within the user interface. In some embodiments, the system may intelligently select an appropriate FPGA design based on connected sensors and desired functionality. In some embodiments, the onboard computer may utilize device tree overlays to manage multiple FPGA configurations. Rather than being limited to a single FPGA image, the system may store multiple FPGA images and use device tree overlays to determine which configuration to load based on the connected peripherals and desired functionality. This may allow the runtime to program and reprogram the FPGA dynamically to support different peripheral combinations and operational modes.

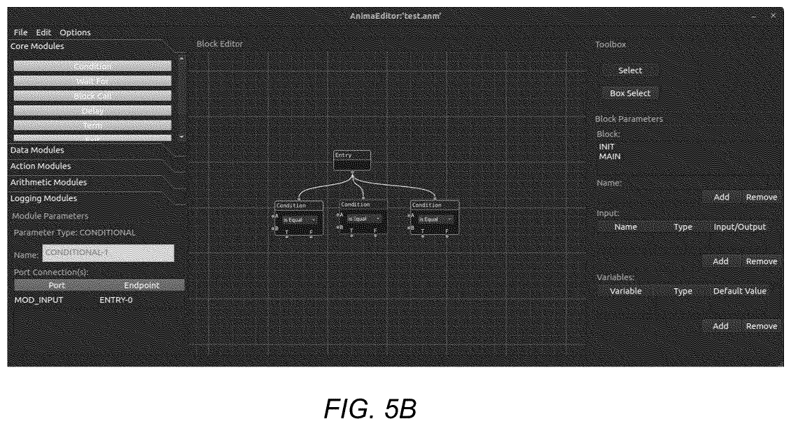

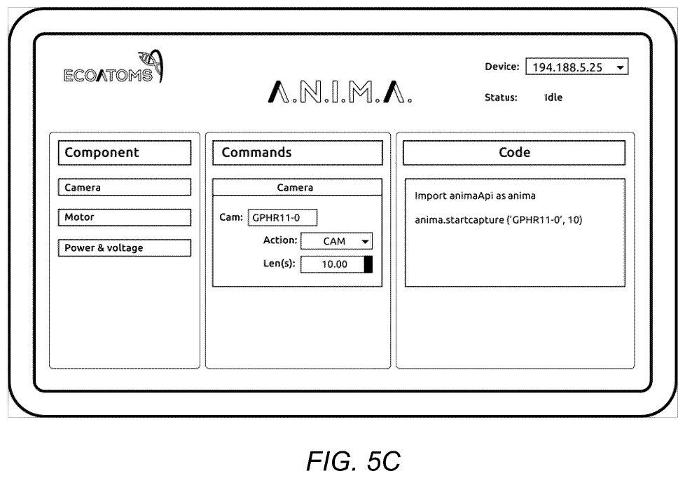

A user can use the user interface to create a program sequence using the peripherals. Example user interface screens in accordance with embodiments of the invention are shown in FIGS. 5A, 5B, and 5C. FIG. 5A illustrates an opening screen that allows selection of starting a new design, opening a previous or saved design, and a configuration tool. FIG. 5B illustrates a graphical user interface with a block editor. The user interface may present various operations and peripherals that are connected to the payload interface and available for use. Different modules that may be selected are shown on the left, which can be placed into the editor window in the center. The block parameters (e.g., input, variables, a condition of equal, greater than, or less than, etc.) may be edited. For example, a box with related configuration values can appear in the sequence editor which can be customized for the target sequence. A simple sequence can be created by adding lights to the sequence first and turning them on. Following this, a sensor peripheral may be added. After the sensor box appears on screen, it may be configured such as setting the frequency for a timer to read values from the sensor. Further, a guard may be enabled that waits until the sensor value read matches or is within a range of values. From here, the user may want to add a camera and set it to start capturing.

The user then may add another condition to stop capturing when the sensor value falls out of range. After the user creates a sequence, it can be uploaded to and/or executed on a payload interface locally through a LAN network. For more advanced users, interfacing Python code for the created sequence can be made available to modify before uploading onto the payload interface. Sequences on the payload interface can utilize a custom Python library that interfaces to the runtime to interface to various peripherals. Further, a Software Development Kit (SDK) can be made available to allow for the integration of custom drivers, software, and FPGA designs for maximal flexibility. FIG. 5C illustrates a user interface for providing a user with the ability to directly edit code. Components are listed on the left (e.g., camera, motor, power & voltage). Commands and their parameters (for a selected component) are listed in the center (e.g., camera, action, lens). A code window appears on the right. For example, the code window may list instructions to import an API and start capture using a camera. In some embodiments, the user interface may display real-time power usage information, including current steady-state power consumption and remaining available power from the system. For example, when operating in passthrough mode and consuming a certain amount of power at a particular voltage, the user interface may indicate how much additional power remains available at that voltage. This may allow users to monitor power budgets and adjust peripheral usage accordingly.

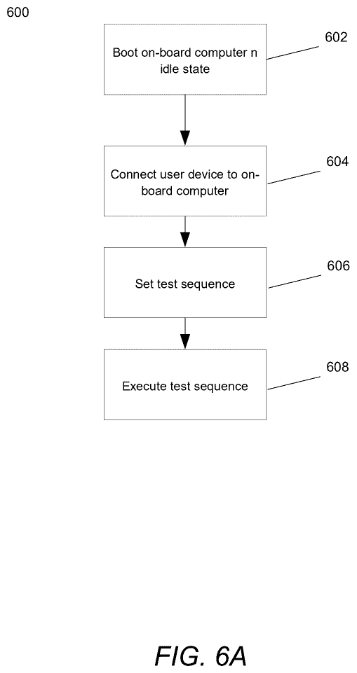

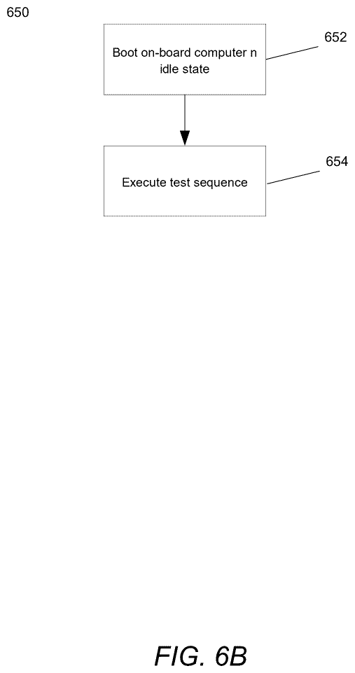

Sequences can be run in user-driven mode or in autonomous mode. In user-driven mode, the payload interface is connected to a computer via a local TCP API or to a spacecraft's networking API. Events can be manually triggered and sequences can be scheduled to start and run at certain times. FIG. 6A illustrates a process for executing a sequence in user-driven model. The process 600 includes booting (602) the onboard computer in idle state. A configuration set for user-driven mode is read, a baseline FPGA design is programmed to the FPGA, and connected peripherals are identified.

A user device (e.g., computer) connects (604) to the onboard computer, which sends its system status, current peripherals connected, and other metadata. The user device can display the user interface (UI). The user can set up (606) a test sequence using the UI. The test sequence can be executed (608).

In autonomous mode, the onboard computer can read in a configuration file (e.g., in JSON) which contains an itinerary of prescheduled sequences. The user may still interact with the onboard computer through local TCP or spacecraft's API, but directly controlling peripherals manually while a sequence is running may be prohibited. FIG. 6B illustrates a process for executing a sequence in autonomous mode. The process 650 includes booting (652) the onboard computer in idle state. A configuration set for autonomous mode is read, an FPGA design as specified in the configuration file is programmed to the FPGA, and connected peripherals are identified.

When a designated time occurs and all needed peripherals are connected, the sequence from the configuration file is executed (654). If any needed peripheral is not connected, the sequence will not be run, the event can be logged, and the onboard computer can wait until the next valid sequence. A user device can optionally be connected to provide a UI, and items of information can be shown on the user device, such as, but not limited to, system status, current peripherals connected, notifier that a sequence is currently running.

While specific processes are discussed above with respect to FIGS. 6A and 6B, one skilled in the art will recognize that any of a variety of processes may be utilized in accordance with embodiments of the invention.

### Reconfiguring FPGA

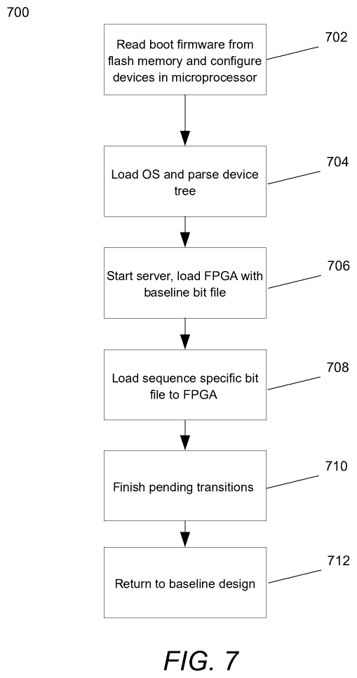

A process for reconfiguring an FPGA of a payload interface in accordance with embodiments of the invention is illustrated in FIG. 7. The process 700 includes reading (702) boot firmware from flash memory and configuring all hardware devices in the microprocessor accordingly. The OS is loaded (704) and the device tree parsed. An FPGA design can be selected as described further above.

A server service is started (706) and the FPGA is loaded with a baseline bit file.

A bit file that is specific to the sequence is loaded (708) to the FPGA. Any pending transactions are finished (710). The FPGA is then returned (712) to the baseline design.

While a specific process is discussed above with respect to FIG. 7, one skilled in the art will recognize that any of a variety of processes may be utilized in accordance with embodiments of the invention.

### Edge Computing Capabilities

To address the challenges of adapting and connecting instruments and modules to a spacecraft, certain embodiments involve a modular hardware architecture integrating a single-board computer designed for artificial intelligence (AI) development and edge computing of the linkings such as, but not limited to, Nvidia Jetson Nano or Orin NX GPU. The space payload interface can integrate with a single-board computer, such as the Nvidia Jetson Nano, designed for AI development and edge computing, enabling the execution of local machine learning models by leveraging the computer's GPU-accelerated parallel processing and onboard memory to analyze sensor data and perform real-time decision-making directly on the spacecraft. A software platform can attempt to create a uniform control system, enabling real-time data processing and autonomous mid-mission adaptation across diverse onboard equipment, enhancing space exploration efficiency.

### Radiation-Hardening and Radiation-Tolerant Designs

The space vehicle interface, may be modified to incorporate radiation-hardened or radiation-tolerant designs and shielding mechanisms to ensure operational integrity during extended space missions, including long-duration stays in orbit or on the lunar surface. Such modifications can include, but are not limited to, the integration of materials with high atomic number (Z) properties, such as lead, tantalum, or advanced polymer composites, capable of attenuating ionizing radiation, including galactic cosmic rays (GCRs) and solar particle events (SPEs). Additionally, electronic components within the space vehicle interface can employ radiation-hardened microprocessors and circuitry, certified to withstand total ionizing dose (TID) levels exceeding 100 krad (Si), as well as redundant system architectures to mitigate single-event upsets (SEUs). Structural enhancements may further encompass layered shielding configurations, water-based or hydrogen-rich barriers, and conformal coatings to protect against secondary radiation effects, in compliance with applicable standards set forth by the National Aeronautics and Space Administration (NASA), the International Organization for Standardization (ISO), and other relevant regulatory bodies. These adaptations may be designed to ensure the Interface's functionality and habitability for mission durations exceeding six (6) months in deep space or lunar environments, while minimizing risks to human occupants and sensitive equipment posed by cumulative radiation exposure.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A space vehicle payload interface, comprising:
an onboard computer including a field-programmable gate array (FPGA) and one or more processors;
a network port configured to provide data connectivity to a space vehicle;
an input power connector configured to receive power from the space vehicle;
a plurality of DC-DC power converters each configured to convert input power from the input power connector to a different output voltage;
a plurality of peripheral connectors configured to connect to peripherals; and
memory coupled to the onboard computer;
wherein the onboard computer is configured to control connected peripherals according to a programmed sequence and to provide data from the peripherals to the space vehicle through the network port.

2. The space vehicle payload interface of claim 1, wherein the memory is error-correcting code (ECC) RAM.

3. The space vehicle payload interface of claim 1, wherein the network port is an Ethernet port.

4. The space vehicle payload interface of claim 3, wherein the Ethernet port is a 1000Base-T Ethernet port.

5. The space vehicle payload interface of claim 1, wherein the input power connector is configured to receive input power in a range of 18 V DC to 60 V DC.

6. The space vehicle payload interface of claim 1, wherein the plurality of DC-DC power converters are configured to provide output voltages including 5 V, 12 V, and 28 V.

7. The space vehicle payload interface of claim 1, wherein the plurality of DC-DC power converters utilize a dual phase buck converter topology with dual inductor outputs.

8. The space vehicle payload interface of claim 1, wherein the plurality of peripheral connectors includes at least one of:
a sensor connector configured to connect to a sensor;
a USB port configured to connect to a USB device;
a motor controller connector configured to connect to a motor; and
a thermoelectric cooler connector configured to connect to a thermoelectric cooler.

9. The space vehicle payload interface of claim 8, wherein the sensor connector is configured to connect to at least one of an oxygen sensor, a carbon dioxide sensor, a humidity sensor, a pressure sensor, a temperature sensor, and an inertial measurement unit.

10. The space vehicle payload interface of claim 8, wherein the motor controller connector is configured to connect to at least one of a brushed DC motor, a stepper motor, and a linear actuator.

11. The space vehicle payload interface of claim 1, wherein the onboard computer is configured to store multiple FPGA configurations and to dynamically load an FPGA configuration based on connected peripherals.

12. The space vehicle payload interface of claim 11, wherein the onboard computer utilizes device tree overlays to manage the multiple FPGA configurations.

13. The space vehicle payload interface of claim 1, further comprising an RS422 serial interface for telemetry and telecommand communication with the space vehicle.

14. The space vehicle payload interface of any of claim 1, wherein the onboard computer is configured to operate in a passthrough mode in which the space vehicle payload interface provides passthrough power to a connected payload, or a plug-n-play mode in which the onboard computer controls connected peripherals according to the programmed sequence.

15. A method for operating a space vehicle payload interface, comprising:
receiving power from a space vehicle through an input power connector;
converting the received power to a plurality of output voltages using one or more DC-DC power converters;
identifying peripherals connected to a plurality of peripheral connectors;
loading an FPGA design to a field-programmable gate array based on the identified peripherals;
executing a programmed sequence to control the connected peripherals; and
transmitting data from the connected peripherals to the space vehicle through a network port.

16. The method of claim 15, wherein converting the received power comprises converting input power in a range of 18 V DC to 60 V DC to output voltages including 5 V, 12 V, and 28 V.

17. The method of claim 15, further comprising:
receiving a user-created programmed sequence through a graphical user interface; and
storing the programmed sequence in memory prior to executing the programmed sequence.

18. The method of claim 17, wherein receiving the user-created programmed sequence comprises receiving a code-less sequence created using a block editor in the graphical user interface.

19. The method of claim 15, wherein executing the programmed sequence comprises operating in one of:
a user-driven mode in which events are manually triggered and sequences are scheduled to start at designated times; and
an autonomous mode in which the onboard computer reads a configuration file containing an itinerary of prescheduled sequences and executes sequences at designated times when all needed peripherals are connected.

20. The method of claim 15, further comprising displaying real-time power usage information on a graphical user interface, the real-time power usage information including current steady-state power consumption and remaining available power from the system.

21. A space vehicle payload system, comprising:
a vehicle adaptor configured to interface with a space vehicle;
a universal cable connected to the vehicle adaptor; and
an onboard computer connected to the universal cable, the onboard computer including:
a field-programmable gate array (FPGA) and one or more processors;
a network port configured to provide data connectivity to the space vehicle through the vehicle adaptor;
an input power connector configured to receive power from the space vehicle through the vehicle adaptor;
one or more DC-DC power converters configured to convert input power to a plurality of output voltages;
a plurality of peripheral connectors configured to connect to peripherals; and
memory coupled to the onboard computer;
wherein the vehicle adaptor is interchangeable to accommodate different space vehicle types.

22. The space vehicle payload system of claim 21, wherein the vehicle adaptor is configured to interface with spacecraft bus interfaces, launch provider interfaces, space station interfaces, and lunar lander interfaces.

23. The space vehicle payload system of claim 21, wherein the onboard computer is configured to operate in a passthrough mode providing passthrough power to a connected payload, or a plug-n-play mode in which the onboard computer controls connected peripherals according to a programmed sequence created using a codeless graphical user interface.

24. The space vehicle payload system of claim 23, wherein the graphical user interface is configured to display real-time power usage information including current steady-state power consumption and remaining available power.

25. The space vehicle payload system of claim 21, wherein the onboard computer further comprises a software platform configured to recreate a mission with simulated events and triggers.
